(19) United States
(12) Patent Application Publication
(10) Pub. No.: US 2008/0232351 A1
(43) Pub. Date: Sep. 25, 2008

(54) IP communication system and IP telephone apparatus

(75) Inventors: Junichi Takahashi, Hamura-shi (JP); Takeshi Nagai, Tokorozawa-shi (JP); Tatsuya Zettsu, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/725,808

(22) Filed: Mar. 20, 2007

(51) Int. Cl. H04L 12/66

(52) U.S. Cl. 370/352

(57) ABSTRACT

During an incoming call, when a client apparatus of an incoming side notifies a client apparatus of an outgoing side of hold of the incoming call, the client apparatus notifies the client apparatus of the hold of the incoming call with OK message which is a response to an INVITE message.

### BACKGROUND OF THE INVENTION

1. Field of the Invention

The present invention relates to an IP telephone apparatus capable of communication in an IP network.

2. Description of the Related Art

A conventional IP telephone apparatus based on 3GPP TS24.228 employs SIP (Session Initiation Protocol) as a call control protocol. When an IP telephone apparatus of an incoming call side requests hold, the IP telephone apparatus transmits an UPDATE request message to notify a partner apparatus that the hold should be started (for example, 3GPP TS24.228 Signaling flows for the IP multimedia call control based on SIP and SDP).

At the hold time, a session media hold device manages the session while maintaining the hold, i.e. the hold is executed while the session is established (for example, JP-A 2005-33715 (KOKAI)).

In the IP telephone apparatus employing the SIP, however, a method of sending/receiving picture and speech data to/from the partner apparatus and a format thereof at the communication time are often different from those at the hold time. In this case, if the hold operation is executed during the incoming call, the method of sending/receiving picture and speech data to/from the partner apparatus and a format thereof are often determined by SIP message processing before the hold operation. To confirm the method and format, the SIP message processing for call establishment and the SIP message processing for the hold need to be executed sequentially. The partner apparatus has to be in the hold state after becoming in a call connection state. In the IP telephone apparatus employing the SIP, a method of sending/receiving picture and speech data to/from the partner apparatus and a format thereof at the communication time are often different from those at the hold time. In this case, if the hold operation is executed during the incoming call, the method of sending/receiving picture and speech data to/from the partner apparatus and a format thereof are often determined by SIP message processing before the hold operation. To confirm the method and format, the SIP message processing for call establishment and the SIP message processing for the hold need to be executed sequentially. The partner apparatus has to be in the hold state after becoming in a call connection state.

### BRIEF SUMMARY OF THE INVENTION

The present invention has been accomplished to solve the above-described problems. The object of the present invention is to provide an IP telephone apparatus which has a few resources required for the processing from the SIP message processing at the call establishment to the SIP message processing at the hold, which has little load on a partner apparatus, and which can be shifted from the call state to the hold state.

To achieve this object, an aspect of the present invention is an IP telephone apparatus executing communication through an IP network. The apparatus comprises a controlling part. If the IP telephone apparatus acts as a caller side, the controlling part executes sending an INVITE message based on the SIP, to an IP telephone apparatus of a callee side based on the telephone number, via a proxy server accommodated in the IP network, if the outgoing call request is input, receiving an OK message sent from the IP telephone apparatus of the callee side, via the proxy server, and establishing a session and holding the communication if the OK message including the information to request the hold is received. If the IP telephone apparatus acts as a callee side, the controlling part executes receiving an INVITE message sent from an IP telephone apparatus of the caller side, via a proxy server accommodated in the IP network, notifying the user of occurrence of an incoming call if the INVITE message is received, accepting a hold request from the user, and sending information indicating a success of the INVITE message and an OK message including information to request hold, to the IP telephone apparatus of the caller side, if the acceptor accepts the hold request.

Accordingly, the present invention can provide an IP telephone apparatus which has a few resources required for the processing from the SIP message processing at the call establishment to the SIP message processing at the hold, which has little load on a partner apparatus, and which can be shifted from the call state to the hold state.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a configuration of an IP communication system according to an embodiment of the present invention;

FIG. 2 is a block diagram showing a configuration of an IP telephone apparatus shown in FIG. 1;

FIG. 3 is a sequence diagram describing operations of the IP communication system shown in FIG. 1; and

FIG. 4 is an example of header information of a response message to be sent from an incoming call side to an outgoing call side as shown in FIG. 3.

### DETAILED DESCRIPTION OF THE INVENTION

An embodiment of the present invention will be described with reference to the accompanying drawings.

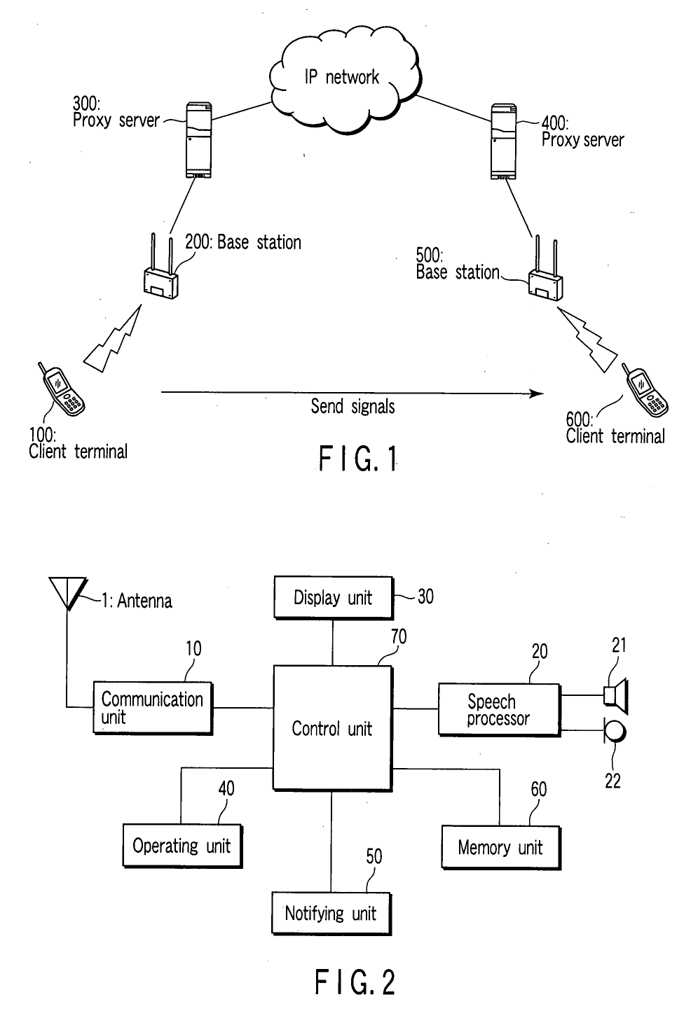

FIG. 1 shows a configuration of an IP communication system according to the embodiment of the present invention. In the IP communication system, a plurality of client apparatuses 100, 600, a plurality of base stations 200, 500 and proxy servers 300, 400 are connected, directly or indirectly, to an IP network.

The client apparatuses 100, 600 are IP telephone apparatuses based on 3GPP TS24.228, which make radio communication with the base stations 200, 500. Each of the client apparatuses 100, 600 is configured as shown in, for example, FIG. 2. In the following descriptions, the client apparatus 100 is regarded as the IP telephone apparatus of the outgoing side and the client apparatus 600 is regarded as the IP telephone apparatus of the incoming side.

Each of the client apparatuses 100, 600 comprises an antenna 1, a communication unit 10, a speech processor 20, a display unit 30, an operating unit 40, a notifying unit 50, a memory unit 60, and a control unit 70.

The antenna 1 receives radio signals transmitted from the base station 200 or 500, and transmits radio signals from the client apparatus to the base station.

The communication unit 10 executes radio communication with the base station via the antenna 1, and executes IP (Internet Protocol) communication with the partner station (client apparatus 600, 100) via the base station. More specifically, the communication unit 10 downconverts and demodulates the radio signal received by the antenna 1, obtains encoded speech data sent from the partner station by down-converting and demodulating the radio signal received by the antenna 1, and outputs the speech data to the speech processor 20 via the control unit 70. In addition, the communication unit 10 modulates the baseband signal with the encoded speech data supplied from the speech processor 20 via the control unit 70, generates a radio signal by up-converting the baseband signal, and sends the generated radio signal to the base station via the antenna 1.

The speech processor 20 regenerates a speech signal by decoding the encoded speech data demodulated by the communication unit 10, and outputs the speech signal by a built-in speaker 21. The speech sent from the partner apparatus is thereby transmitted to the user. In addition, the speech processor 20 generates encoded speech data by encoding a speech signal input from the built-in microphone 22, and supplies the generated encoded speech data to the communication unit 10 by the control unit 70.

The display unit 30 is a display unit employing an LCD (Liquid Crystal Display), etc., which displays various kinds of visual information such as texts, pictures, etc. to the user. The operating unit 40 comprises a plurality of key switches to accept user's requests. The notifying unit 50 notifies the user of incoming calls by sounds.

The memory unit 60 stores control programs and control data of the control unit 70, and telephone directory data associated with telephone numbers, names and picture data such as face pictures, and also stores mail data which have been sent and received, and explanation data related with settings of the client apparatus.

The control unit 70 controls all the units of the client apparatus. For example, the control unit 70 comprises an incoming call controlling function of receiving an incoming signal from the base station under SIP (Session Initiation Protocol), controlling the display unit 30 and the notifying unit 50 to notify the user of occurrence of the incoming call, urging the communication unit 10 to transmit a signal responding to the incoming call by a response operation which the user makes by the operating unit 40, and establishing a speech communication link.

The control unit 70 also comprises an outgoing call controlling function of controlling the communication unit 10 to make an outgoing call to a telephone number designated by the user, in accordance with the SIP, in response to an outgoing call request which the user makes by the operating unit 40, and a communication controlling function of establishing a speech communication link on the basis of the outgoing call.

In other words, the control unit 70 has the controlling functions of implementing the determination of actions, generation of SIP messages, analysis of SIP messages, extraction of data from SIP messages, and sending and reception of SIP messages, in accordance with the SIP.

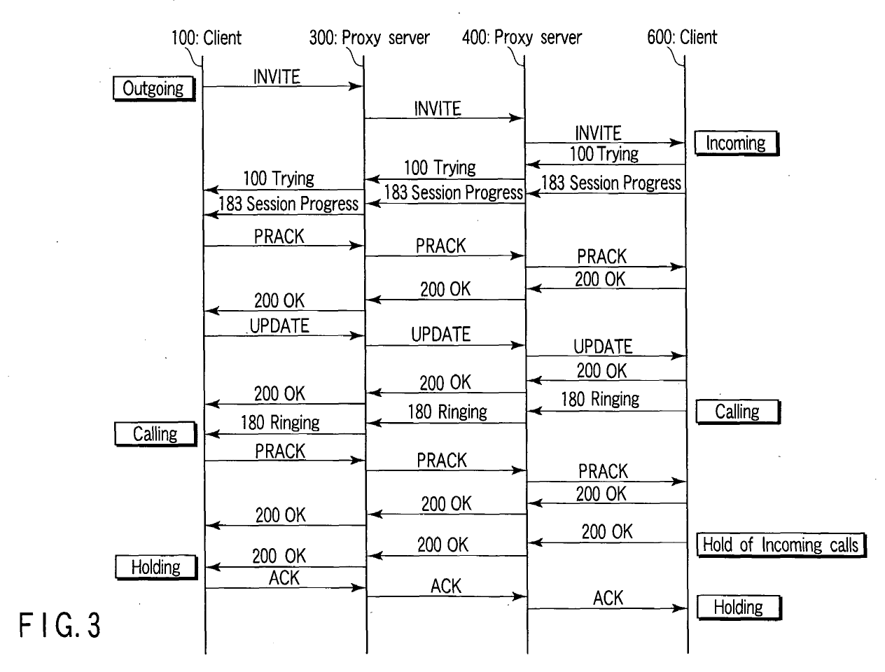

Next, with reference to FIG. 3, operations of the IP communication system having the above configuration are described. In these descriptions, particularly, a call (session) is established between the client apparatuses 100 and 600 according to the present invention, a hold request is given at the client apparatus 600 during the incoming call from the client apparatus 100. A call is established between the client apparatuses 100 and 600, via the proxy servers 300, 400 and the IP network.

First, the user makes an outgoing call request by the operating unit 40, at the client apparatus 100. A telephone number which is previously assigned to the client apparatus 600 is also contained in the outgoing call request. When the control unit 70 detects the outgoing call request, the control unit 70 controls the communication unit 10 to send INVITE message together with the telephone number. This message is received by the base station 200 and transferred to the proxy server 300.

The proxy server 300 having received the INVITE message detects an IP address of the proxy server 400 accommodating the client apparatus 600, from a URI (Universal Resource Identifier) or the telephone number sent together with the INVITE message, and sends the INVITE message to the IP network, by regarding the detected IP address as a message destination.

In the IP network, when the proxy server 400 receives the INVITE message sent from the proxy server 300, the proxy server 400 obtains an IP address of the client apparatus 600 via a location server (not shown), and sends the INVITE message to the obtained IP address regarded as a message destination. The proxy server 400 can often detect from the IP address that the base station 500 accommodates the client apparatus 600.

In the client apparatus 600, when the communication unit 10 receives the INVITE message, the control unit 70 detects the INVITE message, and controls the communication unit 10 to generate and send 100 Trying message indicating that client apparatus is attempting the session. In accordance with the control unit 70, the communication unit 10 sends the 100 Trying message to the proxy server 400 via the base station 500.

The control unit 70 of the client apparatus 600 controls the communication unit 10 to generate and send 183 Session Program message indicating the program of the session. In accordance with the instruction of the control unit 70, the communication unit 10 sends the 183 Session Program message to the proxy server 400 via the base station 500.

The proxy server 400 having received the 183 Session Program message via the base station 500, sends the 183 Session Program message to the IP network. The 183 Session Program message thus sent is transferred to the client apparatus 100 on the basis of information included in a header of the message, and then sent to the client apparatus 100 via the proxy server 300 and the base station 200.

In the client apparatus 100, when the communication unit 10 receives the 183 Session Program message, the control unit 70 detects the 183 Session Program message and controls the communication unit 10 to generate and send PRACK message as a confirmation request for the 183 Session Program message. In accordance with the instruction of the control unit 70, the communication unit 10 sends the PRACK message to the proxy server 300 via the base station 200.

The proxy server 300 having received the PRACK message via the base station 200 sends the PRACK message to the IP network. The PRACK message thus sent is transferred to the client apparatus 600 on the basis of information included in a header of the message, and then sent to the client apparatus 600 via the proxy server 400 and the base station 500.

In the client apparatus 600, when the communication unit 10 receives the PRACK message, the control unit 70 detects the PRACK message and controls the communication unit 10 to generate and send 200 OK message indicating success for the PRACK message. In accordance with the instruction of the control unit 70, the communication unit 10 sends the 200 OK message to the proxy server 400 via the base station 500.

The proxy server 400 having received the 200 OK message via the base station 500 sends the 200 OK message to the IP network. The 200 OK message thus sent is transferred to the client apparatus 100 on the basis of information included in a header of the message, and then sent to the client apparatus 100 via the proxy server 300 and the base station 200.

In the client apparatus 600, the control unit 70 controls the notifying unit 50 and the display unit 30 to audio-visually notify the user that an incoming call has occurred, and controls the communication unit 10 to generate and send 180 Ringing message indicating that the client apparatus 100 is calling the client apparatus 600. In accordance with the instruction of the control unit 70, the communication unit 10 sends the 180 Ringing message to the proxy server 400 via the base station 500.

The proxy server 400 having received the 180 Ringing message via the base station 500 sends the 180 Ringing message to the IP network. The 180 Ringing message thus sent is transferred to the client apparatus 100 on the basis of information included in a header of the message, and then sent to the client apparatus 100 via the proxy server 300 and the base station 200.

In the client apparatus 100, when the control unit 70 detects that the communication unit 10 has received the 180 Ringing message, the control unit 70 controls the speech processor 20 to output a ringback tone from the speaker 21 and notify the user that the client apparatus 100 is calling the client apparatus 600.

In the client apparatus 100, when communication unit 10 receives the 180 Ringing message, the control unit 70 detects the 180 Ringing message and controls the communication unit 10 to generate and send PRACK message as a confirmation request for the 180 Ringing message. In accordance with the instruction of the control unit 70, the communication unit 10 sends the PRACK message to the proxy server 300 via the base station 200.

The proxy server 300 having received the PRACK message via the base station 200 sends the PRACK message to the IP network. The PRACK message thus sent is transferred to the client apparatus 600 via the proxy server 400 and the base station 500.

In the client apparatus 600, when the communication unit 10 receives the PRACK message, the control unit 70 detects the PRACK message and controls the communication unit 10 to generate and send 200 OK message indicating success for the PRACK message. In accordance with the instruction of the control unit 70, the communication unit 10 sends the 200 OK message to the proxy sever 400 via the base station 500.

The proxy server 400 having received the 200 OK message via the base station 500 sends the 200 OK message to the IP network. The OK message thus sent is transferred to the client apparatus 100 on the basis of information included in a header of the message, and then sent to the client apparatus 100 via the proxy server 300 and the base station 200.

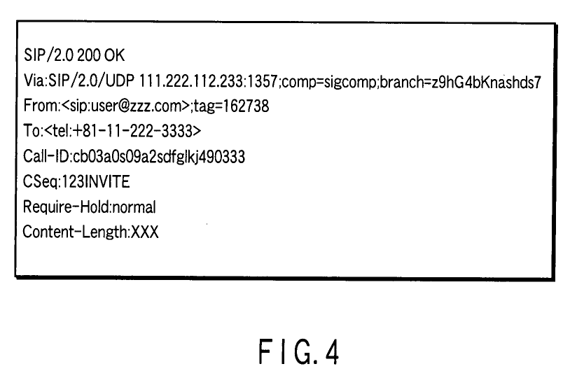

The client apparatus 600 is in the state of notifying the user of the incoming call. At this time, when the user makes a request for holding the incoming call by the operating unit 40, the control unit 70 having detected the request controls the communication unit 10 to generate and send 200 OK message indicating that the INVITE is successful. The 200 OK message is, for example, a header as shown in FIG. 4. In other words, the 200 OK message has “Require-Hold” header field which request the client apparatus 100 of the outgoing side to shift to the hold state. The “Request-Hold” is newly defined in this invention. In accordance with the instruction of the control unit 70, the communication unit 10 sends the 200 OK message to the proxy server 400 via the base station 500.

The proxy server 400 having received the 200 OK message via the base station 500 sends the 200 OK message to the IP network. The 200 OK message thus sent is transferred to the client apparatus 100 on the basis of information included in a header of the message, and then sent to the client apparatus 100 via the proxy server 300 and the base station 200.

In the client apparatus 100, when the communication unit 10 receives the 200 OK message, the control unit 70 detects the reception and discriminates whether or not the header includes “Require-Hold” header field.

When the control unit 70 discriminates that the header includes the “Require-Hold” header field, the control unit 70 controls the communication unit 10 to generate and send ACK message as a confirmation request for the message. In accordance with the instruction of the control unit 70, the communication unit 10 sends the ACK message to the proxy server 300 via the base station 200.

In addition, the control unit 70 reads picture data indicating that the client apparatus 600 is holding, and music data to be reproduced at the hold time from the memory unit 60, urges the display unit 30 to display the pictures based on the picture data and outputs the music data to the speech processor 20, outputs music based on the music data, etc. through the speaker 21, and notifies the user that the client apparatus 600 is holding the incoming call.

The proxy server 300 having received the ACK message via the base station 200 sends the ACK message to the IP network. The ACK message thus sent is transferred to the client apparatus 600 on the basis of information included in a header of the message, and then sent to the client apparatus 600 via the proxy server 400 and the base station 500.

In the client apparatus 600, when the communication unit 10 receives the ACK message and the control unit 70 detects the reception of the message, the control unit 70 controls the notifying unit 50 and the display unit 30 to audio-visually notify the user that the client apparatus 600 is holding the incoming call.

In the IP communication system having the above configuration, when the client apparatus 600 of the incoming side notifies the client apparatus 100 of the outgoing side of the hold of the incoming call during the incoming call, the client apparatus 600 notifies the client apparatus 100 of the 200 OK message which is the response to the INVITE message.

Therefore, by adding the information representing the hold of the incoming call to the 200 OK message which is the response to the INVITE message, not only the call (session) can be established, but the client apparatus 600 can be shifted to the hold state. For this reason, even when the hold is made at the incoming time, the resources required for the processing are reduced, the load on the partner apparatus is light, and the client apparatus can be shifted to the call state to the hold state.

In the above descriptions, INVITE, PRACK, UPDATE, ACK, 100 Trying, 183 Session Progress, 180 Ringing and 200 OK are explained as the SIP messages. Four messages INVITE, PRACK, UPDATE and ACK represent the methods of the request messages, and four messages 100 Trying, 183 Session Progress, 180 Ringing and 200 OK represent status codes of the response messages.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, in the above embodiment, the mobile radio apparatus executing radio communication with the base station is explained as the IP telephone apparatus. However, the IP telephone apparatus is not limited to this, but may be a fixed telephone connected to the proxy server with the wire, and the same advantage can be obtained.

In addition, the client apparatus 100 of the outgoing side is notified of the hold of incoming calls by newly providing the “Require-Hold” at the header of the 200 OK message. Instead of this, however, information to require the hold of incoming calls may be inserted not into the header, but into the body.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An IP telephone apparatus executing communication through an IP network, comprising:
if the IP telephone apparatus acts as a caller side, a controlling part executing,
sending an INVITE message based on the SIP, to an IP telephone apparatus of a callee side based on the telephone number, via a proxy server accommodated in the IP network, if the outgoing call request is input,
receiving an OK message sent from the IP telephone apparatus of the callee side, via the proxy server; and
establishing a session and holding the communication if the OK message including the information to request the hold is received;
if the IP telephone apparatus acts as a callee side, the controlling part executing,
receiving an INVITE message sent from an IP telephone apparatus of the caller side, via a proxy server accommodated in the IP network;
notifying the user of occurrence of an incoming call if the INVITE message is received;
accepting a hold request from the user; and
sending information indicating a success of the INVITE message and an OK message including information to request hold, to the IP telephone apparatus of the caller side, if the acceptor accepts the hold request.

2. The IP telephone apparatus according to claim 1, wherein the occurrence of incoming call is notified via a display unit.

3. The IP telephone apparatus according to claim 1, wherein the IP telephone apparatus executes communication according to SIP (Session Initiation Protocol) as a call control protocol.

4. An IP telephone apparatus executing communication through an IP network, comprising:
an input unit configured to input an outgoing call request and a telephone number to identify an IP telephone apparatus;
a sender configured to send an INVITE message based on the SIP, to the IP telephone apparatus identified by the telephone number, via a proxy server accommodated in the IP network, if the outgoing call request is inputted;
a receiver configured to receive an OK message which is sent from the IP telephone apparatus identified by the telephone number, and which corresponds to the INVITE message, via the proxy server; and
a controller configured to establish a session and holding the communication if the OK message received by the receiver includes the information to request the hold.

5. The IP telephone apparatus according to claim 4, wherein the IP telephone apparatus executes communication according to SIP (Session Initiation Protocol) as a call control protocol.

6. An IP telephone apparatus executing communication through an IP network, comprising:
a receiver configured to receive an INVITE message sent from an IP telephone apparatus of an outgoing side, via a proxy server accommodated in the IP network;
a notifying unit configured to notify the user of occurrence of an incoming call if the receiver receives the INVITE message;
an acceptor configured to accept a hold request from the user; and
a sender configured to send information indicating a success of the INVITE message and an OK message including information to request hold, to the IP telephone apparatus of the outgoing side, if the acceptor accepts the hold request.

7. The IP telephone apparatus according to claim 6, wherein the notifying unit is a display.

8. The IP telephone apparatus according to claim 6, wherein the IP telephone apparatus executes communication according to SIP (Session Initiation Protocol) as a call control protocol.
